(19) United States
(12) Patent Application Publication
(10) Pub. No.: US 2010/0111697 A1
(43) Pub. Date: May 6, 2010

(54) WIND ENERGY GENERATION DEVICE

(75) Inventor: RYAN S. WOOD, BROOMFIELD, CO (US)

Correspondence Address: MARSH, FISCHMANN & BREYFOGLE LLP, 8055 East Tufts Avenue, Suite 450, Denver, CO, 80237, US

(73) Assignee: FRONTLINE AEROSPACE, INC, BROOMFIELD, CO (US)

(21) Appl. No.: 12/611,372

(22) Filed: Nov. 3, 2009

Related U.S. Application Data
(60) Provisional application No. 61/111,559, filed on Nov. 5, 2008.

(51) Int. Cl. F03D 1/02

(52) U.S. Cl. 416/128

(57) ABSTRACT

Wind turbine devices are presented that use counter rotating rotor assemblies in a horizontal axis wind turbine (HAWT) arrangement. This reduces the torque applied to the HAWT thereby reducing the structural requirements of a wind energy generation system. Additionally, the counter rotating rotor assemblies cooperatively rotate an output shaft. In one arrangement, this shaft is a vertical shaft which allows removing power generation equipment from the axis of rotation of a HAWT to a position below the wind turbine and/or located on the ground.

### CROSS REFERENCE

This application claims the benefit of the filing date of U.S. Provisional Application No. 61/111,559 entitled: “Wind Energy Generation Device” and having a filing date of Nov. 5, 2008, the entire contents of which are incorporated by reference.

### FIELD

Presented herein are wind turbine devices for capturing wind energy. More particularly, the presented devices relates to a counter rotating ring fan wind turbine that allows for remotely locating a generator or compressor while substantially eliminating torque caused by gyroscopic procession.

### BACKGROUND

Wind has become a source of electricity by harnessing the kinetic energy of the wind through the use of windmills/wind turbines. Because wind power is free and non-polluting, much attention has recently been given to the capture of wind power. After years of refinement, the three-blade (propeller-type), horizontal-axis wind turbine (HAWT) has become the dominant device for capturing wind energy. Though the three blade HAWT embodies some of the same basic technology used by windmills for thousands of years, it also includes many technological advancements over ancient windmills including computer-controlled, variable pitch blades, blade windfoils optimized through computer modeling, the use of high strength, low weight composites, and reinforced towers, which are often over a hundred meters tall.

The amount of power that a traditional propeller-type windmill can generate is directly proportional to the square of the diameter of the circle of rotation of the propeller tips. This has resulted in three-blade HAWTs with enormous blades used to increase the circle of rotation. These enormous blades are expensive to manufacture and are susceptible to excessive deflection, distortion or failure under heavy loading. Furthermore, the portion of the blade near the axis of rotation provides very little pressure drop and correspondingly, generates very little power. Further, the use of such large blades reduces the rate of revolution of the propeller requiring use of heavy and often costly transmission devices to produce a desire shat input rpm for power generation.

Most HAWTs today have a single rotating-element. When a single rotating-element HAWT turns to face the wind, the rotating blades apply a torque to the propeller blades and the support structure of the HAWT. This torque can quickly fatigue the blade roots, as well as the hub and the axle of the turbine. Some prior art has suggested the addition of teetering hubs to alleviate this fatigue, but this only lessens the effect of the torque rather than eliminating the torque itself.

Furthermore, most HAWTs require that a generator be located near the axis of rotation, usually in a housing aft of the rotating element. In larger three-blade HAWTs, this means that the generator may be hundreds of feet off of the ground. The location of the generator in HAWTs creates great challenges during construction of the turbine and during maintenance of the generator. In combination, the blade size, torque applied to the HAWTs and the weight of power generating machinery supported at the axis of rotation require that a HAWT have a massive support structure/tower and foundations to securely support the system. Construction of these large support structures and foundations adds significantly to the overall cost of construction of a HAWT.

### SUMMARY

To address some of the problems associated with the above noted wind turbine systems, the inventor has determined, inter alia, that use of a counter rotating rotor assembly can significantly reduce the torque applied a HAWT thereby reducing the structural requirements of a wind energy generation system. Additionally, the inventor has recognized that removal of the power generation equipment from the axis of rotation of a HAWT to a position below the wind turbine and/or located on the ground significantly reduces the structural requirements of a support structure/tower utilized support a wind turbine assembly.

According to a first aspect, a wind energy system and method (i.e., utility) is provided that advantageously utilizes a first and second counter rotating rotors. These first and second counter rotating rotors each include a hub and a plurality of blades that extend in a radial direction outwardly from their respective hubs. The plurality of blades are oriented on the first and second rotors such that they rotate these rotors in opposite directions about a common axis of rotation (e.g., horizontal axis of rotation). A shaft is disposed between and rotatively coupled to the first and second rotors. The rotors cooperatively rotate the shaft while the first and second rotors counter rotate. To allow for such cooperative rotation of the shaft, the shaft rotates about an axis that is transverse to the horizontal axis about which the first and second rotors rotate.

In one arrangement, the transverse axis of the shaft is substantially perpendicular to the horizontal axis of the wind turbine rotors. The shaft may be vertically aligned and/or pass through a vertical support structure that supports the rotors above the ground/support surface. This shaft may extend from a location where it is rotatively coupled to the rotors to a position that is below the rotors. In a further arrangement, the shaft may extend from the rotors to near the support surface/ground. In any arrangement, a generator may be coupled to the shaft. Likewise, a transmission assembly may be coupled between the shaft and the generator to produce a desired input RPM for the generator.

In one particular arrangement, the first and second hubs are annular hubs. In this regard, the plurality of blades attached to each rotor may be attached to the annular hubs. In such an arrangement, the shaft may be rotatively coupled to the first and second annular hubs. In one particular arrangement, the first and second hubs form first and second ring gears and a gear interconnected to the shaft engages/meshes with these first and second ring gears. In other arrangements the shaft may be rotatively coupled to the central axis of the first and second rotors.

In a further arrangement, the utility includes a nose and/or a tail cone that may be positioned forward and aft of the first and second rotors, respectively. As utilized herein, the terms forward and aft refer to locations upwind and downwind as measured along the horizontal axis, respectively. In one arrangement, the nose cone has a central axis that is aligned with the horizontal axis and a base that is disposed to adjacent to the first rotor. In one arrangement, the base has a diameter that is at least 50% of the outside diameter of the blades of the first rotor. In a further arrangement, the height of the nose cone is greater than the diameter of its base.

In another aspect, a wind energy system and method (i.e., utility) is provided that utilizes first and second rotors having annular hubs. Each annular hub includes a first plurality of blades that extend in a radial direction from the annular hub. These annular hubs rotate about a common axis and each further include gear teeth on their surfaces. A shaft having a gear is disposed between the first and second annular hubs where the teeth of the gear mesh with the teeth on the first and second annular hubs. When the annular hubs counter rotate, they cooperatively rotate the gear and the shaft.

It will be appreciated that, in order to engage a gear between first and second annular ring gears, it may be desirable to juxtapose the first and second rotors along the horizontal axis about which they rotate. However, in other embodiments multiple gears may be utilized to transfer the rotation from the annular hubs/ring gears to the shaft. In any arrangement, the size and spacing of the gear teeth may be selected to provide a desired output rotation of the shaft for an anticipated rotor rotation, which may be based on an average expected wind velocity.

In another aspect, a wind energy system and method (i.e., utility) is provided that allows for increasing the airflow over the surface of counter rotating rotors. The utility includes a forward rotor and aft rotor each having a plurality of blades extending in a radial direction outward from their respective hubs. A nose cone is provided that extends forward of the forward rotor and has a base that is disposed adjacent to the forward rotor. In one arrangement, the base of the nose cone has a diameter that is at least 50% of the outside diameter of the blades interconnected to the first rotor. The utility further includes a shroud that surrounds at least the forward and aft rotors such that the bladed of the forward and aft rotors rotate within at least a portion of the shroud.

In one arrangement, the shroud is annular and extends from a position forward of the forward rotor and/or forward of the nose cone to a position aft of the aft rotor and/or aft of a tail cone positioned behind the aft rotor. Again, a power take off may be interconnected to the wind energy utility that allows for cooperative rotation of a shaft by the counter rotating forward and aft rotors.

According to another aspect, the wind energy system and method (i.e., utility) is provided that allows for mechanically transferring power from elevated rotors rotating about a horizontal axis to a position on or near a support surface while permitting the rotors to rotate about a vertical axis. The utility includes a vertical support and a nacelle mounted to the vertical support for rotation about vertical axis. The nacelle includes first and second rotors each having a first plurality of blades extending in radial directions. The first and second plurality of blades permit the first and second rotors to counter rotate about a common horizontal axis. A vertical power take off element is disposed between and rotatively coupled to the first and second rotors. In this regard, the first and second rotors cooperatively rotate the power take off element while the first and second rotors counter rotate. Importantly, the vertical power take off element is aligned with and rotates about the vertical axis about which the nacelle rotates. In this regard, when the nacelle turns to face the wind, the vertical power take off element (e.g., shaft, etc.) remains aligned with the nacelle and permits for the transmission of power from the top of the tower to a position below the tower or on/near the support surface.

### BRIEF DESCRIPTION OF THE DRAWINGS

For a more complete understanding of the presented systems and methods and further advantages thereof, reference is now made to the following detailed description taken in conjunction with the drawings in which:

FIG. 1 illustrates a side view of one embodiment of a wind energy device in accordance with various aspects of the invention.

FIGS. 2A-2C illustrate rotor assemblies that may be utilized with the device of FIG. 1.

FIG. 3 illustrates a first power takeoff arrangement.

FIGS. 4A and 4B illustrate a second power takeoff arrangement.

FIG. 5 illustrates a side view of another embodiment of a wind energy device in accordance with various aspects of the invention.

### DETAILED DESCRIPTION

Reference will now be made to the accompanying drawings, which assist in illustrating the various pertinent features of the various novel aspects of the present disclosure. The following description is presented for purposes of illustration and description. Furthermore, the description is not intended to limit the invention to the form disclosed herein. Consequently, variations and modifications commensurate with the following teachings, and skill and knowledge of the relevant art, are within the scope of the presented inventions.

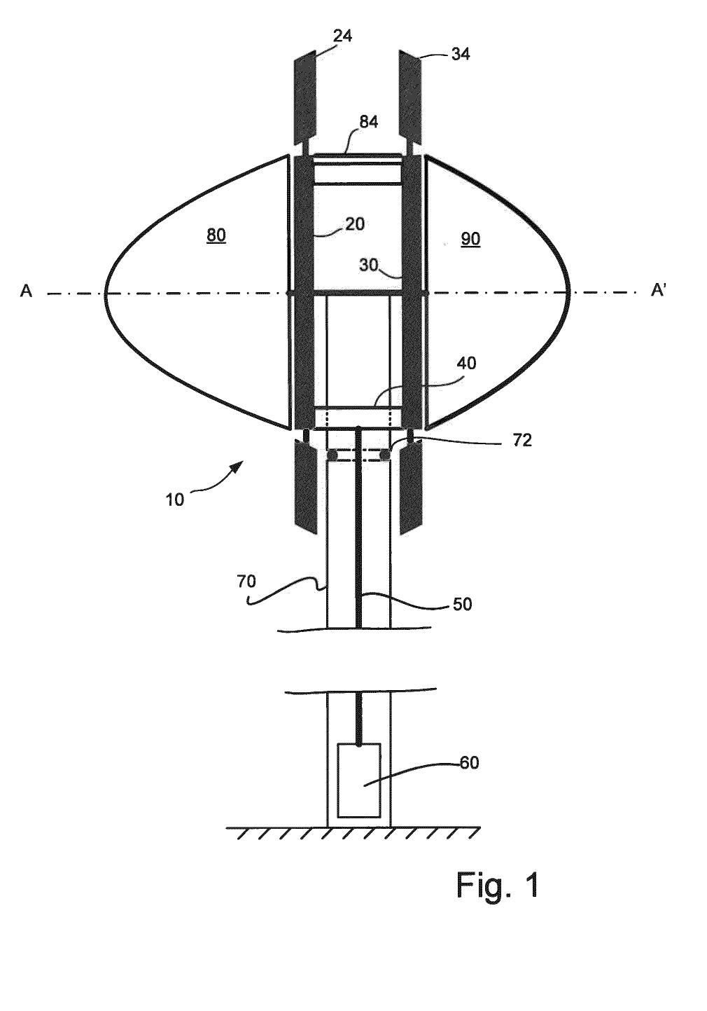

FIGS. 1-4B illustrate one embodiment of a wind energy-generating device in accordance with various aspects of the presented inventions. Generally, the device includes a nacelle rotatively mounted atop a tower/support structure. The nacelle provides a housing and/or necessary support structure (e.g., internal frames, etc.) for supporting a wind turbine assembly. In the present embodiment, the wind turbine assembly utilizes large annular hubs to mount an increased number of blades, which are typically shorter than blades utilized in conventional propeller type wind generators. For increased efficiency, the wind turbine assembly may, though not necessarily, utilize counter rotating rotor assemblies. However, in the present embodiment the wind turbine assembly 10 includes first and second rotors 20, 30 that counter rotate about a common horizontal axis A-A as illustrated in FIG. 1.

In conjunction with the counter-rotating rotors 20, 30, the wind turbine assembly 10 utilizes a power takeoff 40 that is oriented transverse to the axis of rotation A-A of the rotors 20, 30. As shown in FIG. 1, the power takeoff includes a shaft 50 that is oriented perpendicular to the axis of rotation A-A. More particularly, the shaft 50 is oriented, vertically within the support structure 70 of the turbine assembly 10. Use of such a power takeoff assembly 40 allows for moving the power generation elements 60 (e.g., generators, gear boxes, etc.) from a location atop the support structure 70. As will be appreciated, in larger wind turbine systems, the generator may weigh several tons and may further include various gearing systems in order to increase the shaft speed of the generator to, for example, 900-3600 RPM. Increasing of the shaft speed typically requires heavy and costly gear step-up transmission assemblies. This further increases the weight of the system mounted atop of a tower in conventional and turbine systems. Accordingly, this necessitates a massive and costly tower assembly that must likewise be mounted in a massive foundation assembly.

By allowing for the removal of the generator and/or gearing assemblies from the top of the tower or support structures, the present arrangement reduces the structural requirements of the support structure and corresponding foundation assemblies. Further, use of counter-rotating rotors 20, 30 reduces the gyroscopic precession of the turbine assembly 10. That is, the counter-rotating rotors substantially cancel out torque that is applied to the support structure 70 and foundation. Likewise, this reduces the structural requirements of these components.

To reduce the size, complexity and cost of the blades/air foils of the wind turbine assembly 10, the rotors 20, 30 utilize a hub 22, 32 of increased diameter in relation to conventional horizontal axis wind turbines (HAWT). As will be appreciated, in conventional wind turbines, hubs are of small diameter, generally not much wider than the shafts to which they are attached. This small diameter provides a limited surface area to which blades can be attached and thereby limits the number of blades on the wind turbine as well as limiting the width of such blades. The hubs 22, 32 of the present wind turbine are of significantly greater diameter allowing a larger number of blades 24, 34 to be used to collect wind energy.

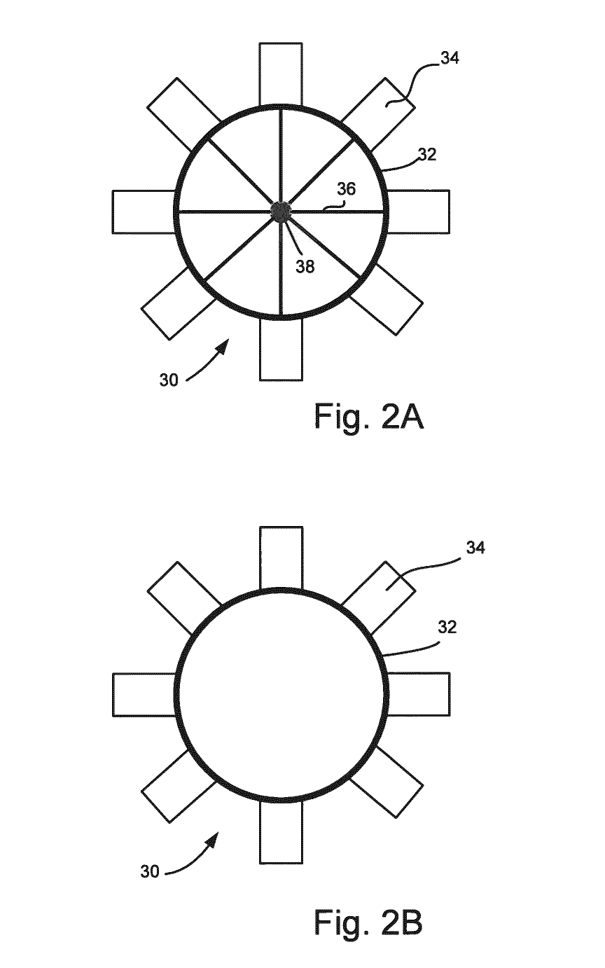

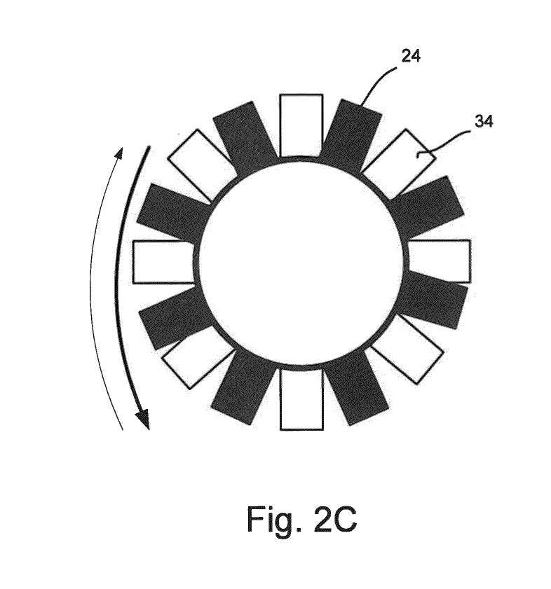

One rotor assembly 30 is illustrated in FIG. 2A. It will be appreciated that both rotor assemblies 20, 30 may be substantially identical. As shown in FIG. 2A, the rotor assembly is an annular hub and spoke assembly where a plurality of spokes 36 interconnect an axel 38 to the annular hub 32. In FIG. 2B, the rotor assembly 30 only includes the annular hub 32 and attached blades 34. In such an arrangement, it will be appreciated that the annular hub 32 may mate with a race or other bearing assembly of the wind turbine assembly. As noted, the wind turbine assembly may include a nacelle that may provide enclosures and/or support structures for the rotors and/or nose cone and tail cone as discussed herein. Either of the arrangements of FIGS. 2A and 2B, which utilize the annular hub 32, provides an increased hub periphery that allows for increasing the number of blades that may be attached to the hub.

It will be appreciated that use of an annular hub with an increased diameter relative to hubs of conventional wind turbines does not detract from the ability of the turbine to capture wind energy. It is well known that the inner portions of most turbine blades do not collect an appreciable amount of wind energy. That is, the majority of wind energy collected by a turbine is from the outer two-thirds or outer half of the turbine blades. Accordingly, elimination of the inner portion of such blades does not significantly reduce the amount of energy that may be collected. In fact, the elimination of the inner portion of such blades allows for the interconnection of additional blades to the large diameter hub and thereby may allow for increased wind collection.

The hubs 30 may be scaled for different applications. In this regard, the hubs may vary in size from between about 5 feet in diameter to over 50 feet in diameter or more. Such hubs may be made of any appropriate material including, without limitation, aluminum, steels and composite materials.

Use of the increased diameter hubs also allows for use of shorter blades 34. That is, the blades may be considerably shorter than those conventionally used in power generating wind turbines, which can be in excess of 100 feet in length. The length of such blades may depend upon the diameter of the hub, which, as noted above, is scalable for a particular application. That is, such blades may vary in length. In any arrangement, the ability to utilize shorter blades than those utilized in larger conventional wind turbines allows for reduced blade construction costs as well as reduced structural requirements for each of the blades. For instance, shorter blades experience fewer harmonics compared with longer blades. Of course, such harmonics can lead to fatigue and blade failure. Reducing such harmonics reduces blade failure potential and/or reduces design requirements for the blades. The blades may be made of any material known in the art for construction of such blades. Such materials may include, without limitation, aluminum, steels and composite materials such as fiberglass reinforced materials, carbon fibers, and/or wood epoxy.

It will be appreciated that the blades are attached to their respective hubs at an angle to provide a desired direction of rotation. For instance, as illustrated in FIG. 1, the blades 24 of the forward rotor (i.e., upwind rotor) may each be oriented at a common angle to provide rotation in a first direction (e.g., clockwise). In contrast, the blades 34 of the aft or downwind rotor 30 may be oriented in a substantially opposite direction to produce rotation in an opposite direction (e.g., counterclockwise). This is illustrated in FIG. 2C. It will be appreciated that the angle of such blades may vary. Furthermore, such blade angles may be dynamically variable. In this regard, each blade may be mounted to the hub, utilizing a variable pitch mounting assembly.

The blades themselves may be constructed in any appropriate manner known within the airfoil arts. For instance, the leading edges of the blades may each be curved to reduce turbulence as they pass through the air. Likewise, the trailing edge may be tapered and/or the distal ends of the blades may be wider than the central portion of the blades. Other blade variations are possible and considered within the scope of the present invention.

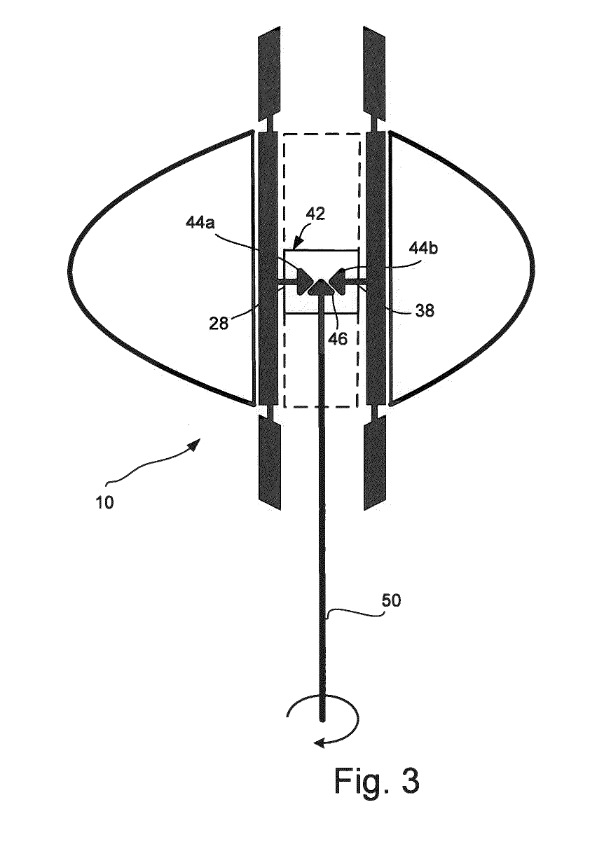

As noted above, the wind turbine assembly 10 utilizes a power takeoff 40 that is transverse to the axis of rotation A-A of the first and second rotors 20, 30. It will be appreciated that the counter-rotation of the rotors 20, 30 may be utilized to collectively turn the power takeoff assembly. For instance, in a first embodiment illustrated in FIG. 3, the power takeoff assembly 40 includes a gearbox 42 that couples the central axes of the first and second rotors 20, 30 (i.e., along horizontal axis A-A) to the output shaft 50. In this arrangement, the first and second rotors may be configured similarly to that as shown in FIG. 2A wherein each rotor 20, 30 has a central axle 28, 38. As shown, these axels may each include a bevel gear 44A, 44B on their facing ends. These bevel gears 44A, 44B may mesh with a mating bevel gear 46 fixedly connected to the upper end of the shaft 50. It will be appreciated that the counter-rotation of the first and second rotor assemblies 20, 30 is thereby translated into a common rotation in the transfers/vertical axis of the shaft 50. Accordingly, the energy applied to the shaft 50 by the first and second rotors may be transferred to the generator 60, which may be located on a ground surface or otherwise below the nacelle of the wind energy device.

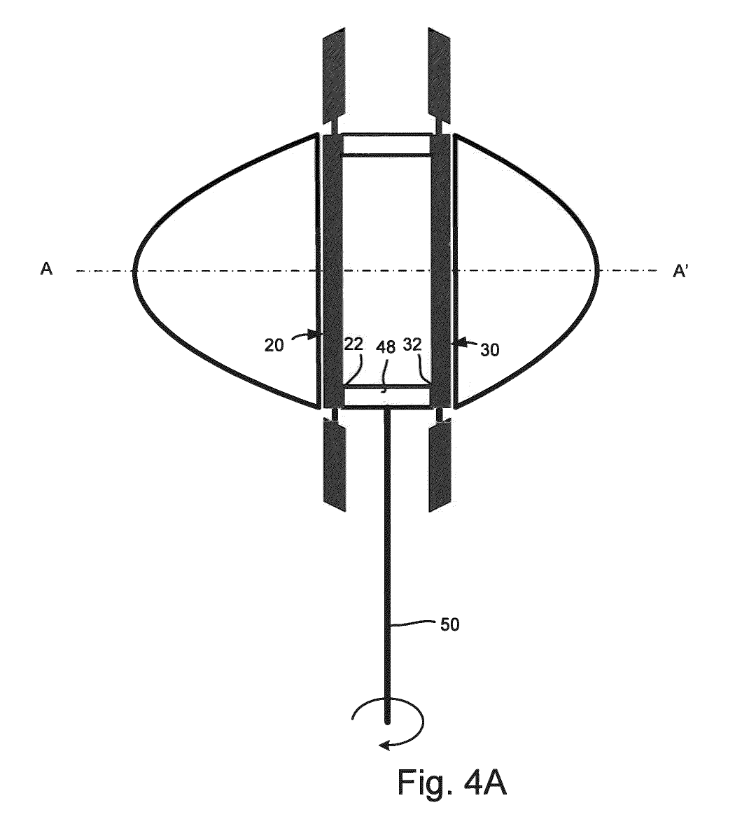

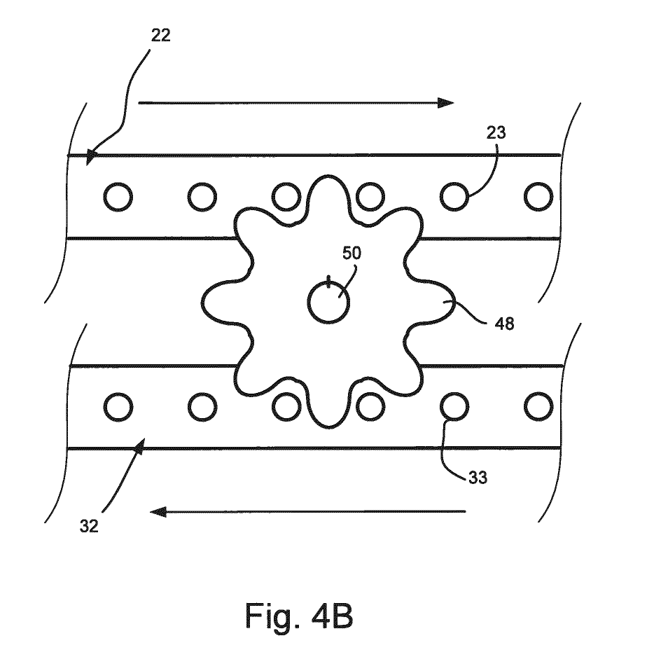

FIGS. 4A and 4B illustrate a second embodiment of a power takeoff assembly. As shown in FIG. 4A, the output shaft 50 is coupled to the annular hubs 22, 32 of the rotors 20, as opposed to the central axes/axels thereof. FIG. 4B illustrates the interconnection between these components. As shown, a gear 48 is fixedly interconnected to the top of the output shaft 50. This gear 48 meshes with teeth 23, 33 that are affixed to the first and second hubs 22, 32, respectively. In this regard, the first and second hubs may form ring gears that are adapted to mesh with the gear 48 of the output shaft 50. Such an arrangement may be used with the rotor configurations of either FIG. 2A or 2B. Again, the counter-rotation of the first and second hubs 22, 32 allows for conjunctively rotating the output shaft 50 about an axis that is transverse to the axis of rotation of the first and second rotors 20, 30. A further benefit may be achieved by moving the power takeoff assembly 40 from the central axes of the rotors to a location spaced from these axes. Namely, the rotation of the output shaft 50 may be greatly increased in relation to rotation of a shaft coupled to the central axes of the first and second rotors due to the increased diameter of the ring gears. This increased rate of rotation may reduce the need and/or requirement to increase the rotation of the output shaft 50 as received by the generator 60. That is, in some embodiments, the rotation of the output shaft 50 may be sufficient to provide the necessary input RPM for the generator 60. Of course, size and spacing of the gear teeth on the hubs and the size of the gear (e.g., number of teeth) may be selected to achieve a desired output RPM for an expected wind velocity. This may further simplify the system by reducing the need or complexity of a transmission system.

Referring again to FIG. 1, it will be noted that the wind turbine assembly 10 may be mounted on any appropriate tower, as is known in the art. Towers are often cylindrical and made of steel, though lattice towers may also be utilized. The height of the tower may be selected based on the scaling of the rotors as discussed above. In addition, the support structure/tower 70 may also include a rotation mechanism 72 in order to allow the nacelle and turbine assembly disposed on the tower to rotate horizontally about a vertical axis. Such a rotation assembly 72 may allow the turbine to turn such that it faces into the wind. It will be appreciated that this mechanism may be a passive central mechanism wherein the design of the turbine assembly, nose cones and/or tail/aft cones, as discussed herein, or other portions of the assembly allow for passively aligning the turbine assembly with the wind. Such passive control mechanisms may include designing the turbine assembly such that a mass center lies slightly towards the downwind direction to render the assembly self-aligning. However, it will be further appreciated that active control systems may be utilized wherein one or more motors are operative to rotate the turbine assembly 10 to a desired orientation with the wind. Such active control assemblies may include various rotors, gears, servo control units, etc. Any assembly may further include braking assemblies and/or locking assemblies that allow for locking the turbine assembly 10 at a desired location.

In addition, the rotation assembly 72 may, in some embodiments, allow for adjusting the tilt/yaw of the wind turbine assembly. In the present embodiment, rotation of the nacelle/wind turbine assembly about the support structure 70 is aligned with the rotational axis of the output shaft 50. This alignment of the vertical rotation of the wind turbine assembly 10 and the output shaft 50 allows for turning the wind turbine assembly without requiring adjusting the position of the output shaft 50.

The amount of power that a conventional HAWT wind turbine can generate is considered directly proportional to the square of the diameter of the circle of rotation of the propeller tips, as well as the cube of the wind velocity. As noted above, the wind passing over a central portion of conventional propeller type turbines provides little benefit to the power generation of such turbines. Accordingly, one embodiment of the present invention utilizes a streamlined body that directs airflow, which would otherwise pass through the hubs of the rotors, over the blades of the rotors. In this regard, kinetic energy of the wind within the overall diameter of the turbine may be more effectively captured. As shown in FIG. 1, embodiments of the wind turbine assembly 10 may utilize a nose cone 80 and a tail cone 90 to generate a streamlined body that accelerates air over the first and second rotors 20, 30. As shown, the nose cone 80 is interconnected windward (i.e., forward) of the first rotor 20 and the tail cone 90 is positioned aft of the second rotor 30. It will be further noted that in between the first and second rotors 20, 30 the wind turbine assembly 10 may include a cowling 84. In this regard, the nose cone, tail cone and cowling effectively define a housing of the nacelle and wind turbine assembly.

The nose cone 80 is configured in the present embodiment as a cone. In a preferred embodiment, the diameter of the base of the cone is in excess of 50% of the outside diameter of the blades of the first rotor 20. In this regard, wind that would otherwise pass through the center of the rotors is directed over the blades. As will be appreciated, this increases the torque or rotational force that may be generated by the rotor 20. Use of the nose cone also allows for accelerating the air over its surface such that it is provided to the blades of the rotor with an increased velocity. This air then passes over the blades turning the first rotor. Air passing through the blades of the first rotor 20 is then passed over the blades of the second rotor 30 resulting in its counter-rotation. In this regard, it will be appreciated that it may desirable that the first and second rotors be closely juxtaposed along the rotational axis A-A. Once the air passes over the second rotor 30, the air continues to pass over the tail cone 90 which reduces the turbulence of the air as it re-mergers with ambient air.

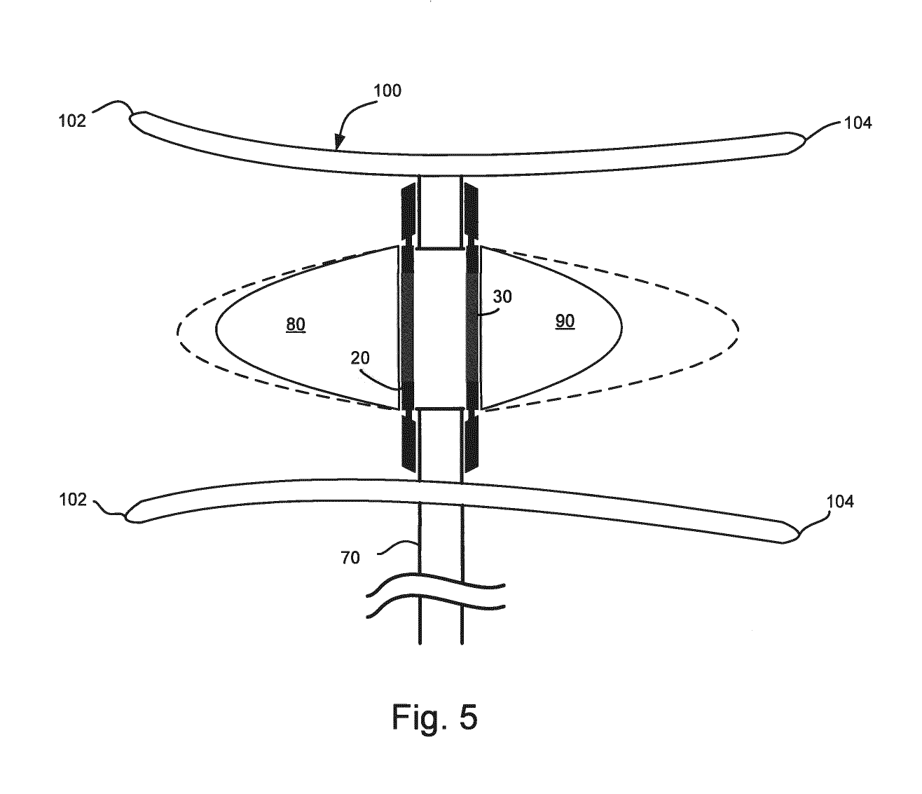

Generally, the shape of the nose cone allows for accelerating laminar airflow around the nose cone to provide increased airflow and velocity to the rotors while the tail cone allows air to merge with the surrounding wind with minimal induced turbulence. It has been determined that use of a nose cone may increase the wind speed to the blades by over 20%. In one arrangement, it has been determined that a preferred shape for the nose cone is a prolate spheroid. That is, a nose cone that has a height that is greater than its base diameter. However, it will be appreciated that the size and configuration of the nose and tail cones may be selected for particular conditions of a particular application. For instance, different geographical locations may have different average wind velocities. Accordingly, such different average wind velocities may dictate use of differently sized and/or curvatured nose and/or tail cones. Use of different sized tail cones is shown in phantom in FIG. 5.

To further improve the efficiency of the wind turbine assembly 10, some embodiments of the presented devices may utilize an external cowling or airfoil 100. As shown in FIG. 5, this air cowling may surround the first and second rotors and thereby funnel additional captured air over the rotors. In this regard, it will be appreciated that the inside diameter of a forward edge 102 of the cowling 100 may be greater than the inside diameter of the portions of the cowling 100 adjacent to the rotors 20, 30. In this regard, additional air may be captured ahead of the rotors and accelerated over the inside surface of the cowling 100 prior to passing over the rotors. In this regard, the cowling acts similar to the nose cone and provides a means for laminar acceleration of captured air. The aft portion 104 of the cowling extends outward to merge the exhausted air passing over the rotors with the surrounding wind with minimum induced turbulence.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1. A wind energy system, comprising:
a first rotor having a first hub and a first plurality of blades extending in a radial direction outward from the first hub, the first rotor being operative to rotate about a horizontal axis;
a second rotor having a second hub and a second plurality of blades extending in a radial direction outward from the second hub, the second rotor being operative to rotate about the horizontal axis, wherein the first and second plurality of blades are oriented such that the first and second rotors counter rotate about the horizontal axis;
a vertical support supporting the first and second rotors above a support surface; and
a shaft disposed between and rotatively coupled to the first and second rotors, wherein the first and second rotators cooperatively rotate the shaft while the first and second rotors counter rotate, wherein the shaft rotates about an axis that is transverse to the horizontal axis.

2. The system of claim 1, wherein the first and second rotors are juxtaposed along the horizontal axis.

3. The system of claim 1, wherein the shaft extends between a first position proximate to the first and second rotors and a second position proximate to the support surface.

4. The system of claim 3, wherein the first and second rotors are rotatively coupled to the vertical support to rotate about a vertical axis, wherein the shaft rotates about the vertical axis.

5. The system of claim 1, further comprising:
a generator coupled to the shaft.

6. The system of claim 1, wherein the first and second hubs are annular hubs

7. The system of claim 6, wherein the first and second hubs form first and second ring gears.

8. The system of claim 8, wherein the shaft further comprises:
a gear, wherein the gear engages the first and second ring gears.

9. The system of claim 1, further comprising:
a gear box, the gear box coupling rotational axes of the first and second rotors with the shaft.

10. The system of claim 1, further comprising:
an air deflector disposed adjacent to the first rotor.

11. The system of claim 10 wherein the air deflector comprises:
a nose cone having a central axis aligned with the horizontal axis and a base disposed adjacent to the first rotor.

13. The system of claim 11, wherein the base has a diameter that is at least 50% of diameter of the blades.

14. The system of claim 11, wherein a height of the nose cone measured from the base to an apex of the cone is greater than a diameter of the base.

15. The system of claim 11, further comprising:
a tail cone.

16. The system of claim 1, further comprising:
a shroud extending around at least a portion of the first and second rotors.

17. The system of claim 16, further comprising:
a nose cone having a base disposed adjacent to the first rotor, wherein the shroud extends to a location along the horizontal axis forward of an apex of the nose cone.

18. The system of claim 17, further comprising:
a tail cone having a base disposed adjacent to the second rotor, wherein the shroud extends to a location along the horizontal axis aft of an apex of the tail cone.

19. A wind energy system, comprising:
an forward rotor having a first hub and a first plurality of blades extending in a radial direction outward from the first hub, the forward rotor being operative to rotate about a horizontal axis;
a nose cone having a central axis aligned with the horizontal axis, wherein a base of the cone is disposed adjacent to the forward rotor and wherein the nose cone has a diameter that is at least 50% of an outside diameter of the first plurality of blades.
an aft rotor having a second hub and a second plurality of blades extending in a radial direction outward from the second hub, the aft rotor being operative to rotate about the horizontal axis, wherein the first and second plurality of blades are oriented such that the forward and aft rotors counter rotate about the horizontal axis and wherein the forward and aft rotors are juxtaposed along the horizontal axis;
a vertical support supporting the forward and aft rotors above a support surface; and
a power take off element disposed between and rotatively coupled to the forward and aft rotors, wherein the forward and aft rotors rotators cooperatively rotate the power take off element while the forward and aft rotors counter rotate.

20. The system of claim 19, wherein a height of the nose cone measured from the base to an apex of the cone is greater than a diameter of the base.

21. The system of claim 19, further comprising:
a tail cone having a base disposed adjacent to the aft rotor.

22-39. (canceled)

40. A wind energy system, comprising:
a vertical support;
a nacelle mounted to the vertical support for rotation about a vertical axis, the nacelle including:
a first rotor having a first hub and a first plurality of blades extending in a radial direction outward from the first hub
a second rotor having a second hub and a second plurality of blades extending in a radial direction outward from the second hub, wherein the first and second plurality of blades are oriented such that the first and second rotors counter rotate about a horizontal axis;
a vertical power take off element disposed between and rotatively coupled to the first and second rotors, wherein the first and second rotators cooperatively rotate the power take off element while the first and second rotors counter rotate, wherein the vertical power take off element is aligned with and rotates about the vertical axis.

41. The system of claim 4, wherein the vertical power take off comprises:
a shaft that extends from a location rotatively connected with the first and second rotors to a location below the nacelle.

42. The system of claim 41, wherein the shaft extends proximate to a support surface of the vertical support.
